(19) United States
(12) Patent Application Publication
(10) Pub. No.: US 2021/0306168 A1
(43) Pub. Date: Sep. 30, 2021

(54) PARTICIPANT IS CALLED WHEN IT IS TIME TO JOIN A MEETING

(71) Applicant: T-Mobile USA, Inc., Bellevue, WA (US)

(72) Inventor: Karthik ADEPALLI SRI LAKSHMI, Bellevue, WA (US)

(21) Appl. No.: 16/836,574

(22) Filed: Mar. 31, 2020

(51) Int. Cl. H04L 12/18; H04M 3/56

(52) U.S. Cl. CPC H04L 12/1818; H04L 12/1822; H04M 3/565

(57) ABSTRACT

A system to call a participant to join and connect to a meeting is described herein. The system includes a meeting server and a communication server. The meeting server is programmed to set the meeting and call a participant based on the response to a meeting request. The communication server is programmed to send the meeting request to the participant by one or more communication methods or protocols.

### BACKGROUND

Currently, meetings are scheduled via one or more programs or applications. Notifications can be set to notify the participant of the upcoming meeting. However, in some instances, these programs or applications do not remind a participant about the upcoming meeting. Therefore, the host, participant, or both, are required to set their own notifications. In other instances, these programs or applications integrate with other aspects of the program or application to notify the participant about the upcoming meeting. However, these notifications may go unnoticed or be disregarded.

Missing a meeting can have unintended consequences. For example, the meeting may need to be rescheduled, thereby delaying work that would have resulted from the meeting. Additionally, to ensure that the participant does not miss the meeting, the participant may join early. In this example, productivity decreases since the participant is sitting around and waiting for the meeting to begin, rather than completing various work and tasks.

What is a needed is a system that increases the efficiency of user participation. What is further needed is a system that reliably hosts a meeting.

### BRIEF DESCRIPTION OF THE DRAWINGS

FIG. 1A illustrates an example system to schedule a meeting.

FIGS. 1B-1C illustrate example responses.

FIG. 1D illustrates an example meeting server of the example system.

FIG. 2 illustrates an example method for schedule a meeting.

FIG. 3 illustrates an example system to call one or more participants of a meeting.

### DETAILED DESCRIPTION

A system to call a participant to join and connect to a meeting is described herein. The system is programmed to contact a participant based on the participant's response, which is further based on the participant's availability or desired time to join, and place the participant into conference, such via a conference communication link. The conference, for example, can be a communication link that allows for audio/visual communication links to be transmitted and received between two or more users' equipment, including user equipment of at least one host and user equipment of at least one participant.

The system includes a meeting server and a communication server. The meeting server is programmed to set the meeting and call a participant based on the response to a meeting request. The communication server is programmed to send the meeting request, including the conference communication link, to the participant by one or more communication methods or protocols.

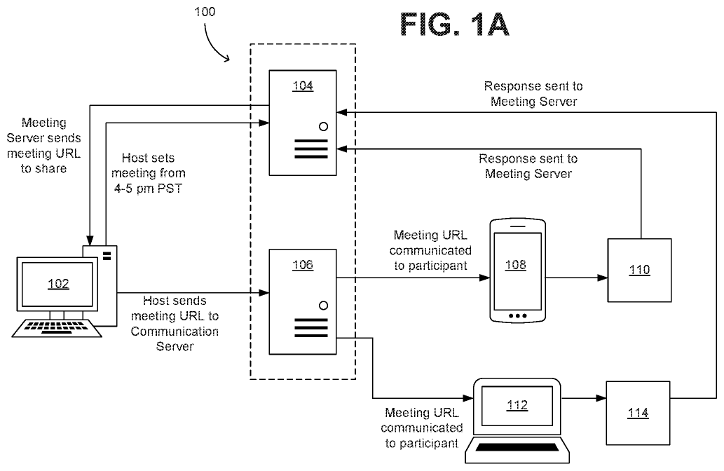

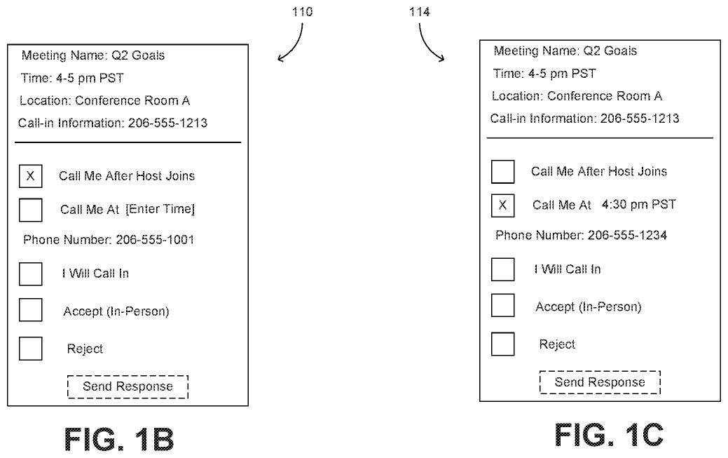

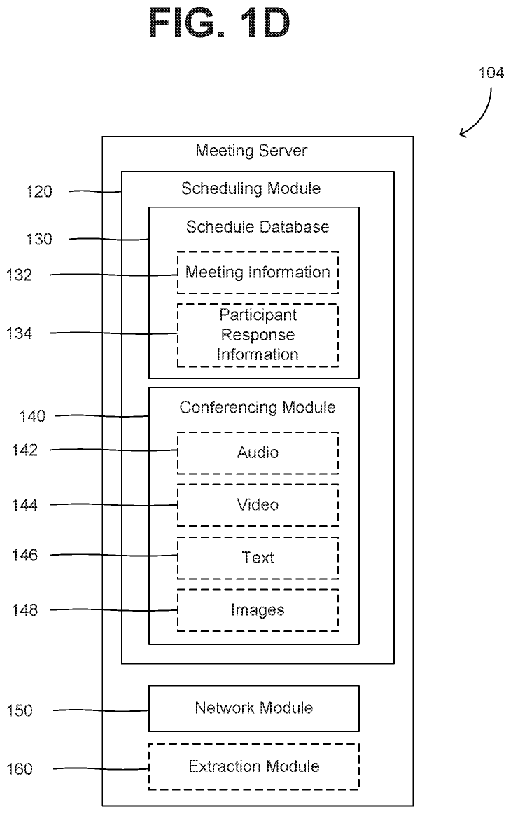

FIG. 1 shows a system 100 for scheduling a meeting. The system 100 includes a meeting server 104 and a communication server 106. The meeting server 104 is programmed to set the meeting, create a uniform resource locator (URL) for the meeting, and call one or more participants based on one or more received responses to a meeting request.

The meeting server 104 includes one or more network protocols to communicate with a host user equipment 102, a first participant user equipment 108, and a second participant user equipment 112. The meeting server 104 also includes one or more network protocols to transmit data between the meeting server 104 and the host user equipment 102, the first participant user equipment 108, and the second participant user equipment 112. For example, the meeting server 104 can include a session initiation protocol (SIP) for initiating, maintaining, and terminating real-time sessions which include voice, video, and messaging applications. The SIP signals and controls multimedia communication sessions. As another example, the meeting server 104 can also include a real-time transport protocol (RTP) for delivering audio and video over internet protocol networks. As yet another example, the meeting server 104 can also include a transmission control protocol (TCP) for communicating over a network, such as by dividing any message into packets which are sent to the destination from the source to be reassembled. As yet another example, the meeting can also include an internet protocol (IP) as an addressing protocol, which is mostly used with TCP. The IP addresses the packets, such as those formed by the TCP, to help route them through the network, such as via one or more nodes, until the packet or packets reach the destination.

The meeting server 104 includes one or more network protocols for receiving user responses 110, 112 and sending the URL to the host user equipment 102. These network protocols can send, distribute, receive, or transfer e-mails or files. For example, the meeting server 104 can include one or more protocols to send and receive e-mails, including post office protocol (POPS), internet message access protocol (IMAP), simple mail transfer protocol (SMTP), or combinations thereof.

The meeting server 104 can also include one or more network protocols for transferring hypertext between two or more systems. These protocols can include hypertext transfer protocol (HTTP) and hypertext transfer protocol secure (HTTPS).

The communication server 106 is programmed to transmit the meeting request, which can include the URL, from the host user equipment 102 to the first participant user equipment 108 by one or more communication methods or protocols. The meeting request can be transmitted by the communication server 106 by e-mail, text (including real time text), audio (including with touch tones), or any appropriate method or protocol by which a response from the first participant user equipment 108 can be transmitted and received by the meeting server 104. The host user equipment 102 can also receive the response from the first participant user equipment 108 via the meeting server 104, the communication server 106, or any appropriate intermediary or communication method or protocol. In other words, in one embodiment, the communication server 106 is programmed to receive a meeting request from the host user equipment 102, the meeting request having a meeting feature that includes one or both of a request to initiate a conference communication link when the host user equipment 102 is coupled to the conference communication link and an instruction to generate a conference initiation request at a pre-determined time. The communication server 106 is also programmed to generate the meeting invitation based on the feature of the meeting request and transmit the meeting invitation to the first participant user equipment 108, the second participant user equipment 112, or both.

In another embodiment, the communication server 106 is programmed to transmit an instruction to the host user equipment 102, to transmit the meeting invitation to the first and send participant user equipment 108, 112, or both.

The communication server 106 includes one or more network protocols to communicate with the host user equipment 102, the first participant user equipment 108, and the second participant user equipment 112. The communication server 106 also includes one or more network protocols to transmit data between the communication server 106 and the host user equipment 102, the first participant user equipment 108, and the second participant user equipment 112. For example, the communication server 106 can include TCP, IP, or both.

The communication server 106 includes one or more network protocols for receiving the URL from the host user equipment 102 and sending to the first participant user equipment 108 and the second participant user equipment 112, such as by e-mail. These network protocols can send, distribute, receive, or transfer e-mails or files. For example, the communication server 106 can include POPS, IMAP, SMTP, or combinations thereof.

The communication server 106 can also include one or more network protocols for transferring hypertext between two or more systems, such as HTTP or HTTPS.

In one embodiment, the communication server 106 is further programmed to transmit the meeting request from the host user equipment 102 to the first participant user equipment 108 and the second participant user equipment 112 by one or more communication methods or protocols. In another embodiment, the communication server 106 is further programmed to transmit the meeting request from the host user equipment 102 to a plurality of participant user equipment, including the first participant user equipment 108, the second participant user equipment 112, and one or more other participant user equipment, by one or more communication methods or protocols.

The host user equipment 102, the first participant user equipment 108, and the second participant user equipment 112 can be any device used by an end-user for communication purposes, including, without limitation, a smartphone, a mobile phone, a telephone, a tablet, a personal digital assistant, a laptop, a desktop, or the like.

The first participant user equipment 108 and the second participant user equipment 112 are programmed to send a first participant response 110 and a second participant response 112, respectively, to the meeting server 104.

FIGS. 1B-1C show the first and second participant responses 110, 112, respectively. The first and second participant responses 110, 112 include the same general meeting information (e.g., meeting name, meeting time, meeting location, call-in information, and any other appropriate information for scheduling or identifying the meeting) and the same response options (e.g., “Call me after host joins,” “Call me at [insert time],” “I will call in,” “Accept (in person),” and “Reject”). The first and second participant responses 110, 112 also include an area into which the first and second participants' phone numbers can be included. The first and second participant responses 110, 112 can also include a “Send Response” button to send the response to the meeting server 104, such as when the first and second participant responses 110, 112 have not yet been sent.

In FIG. 1B, the first participant response 110 is shown. The first participant has selected “Call me after the host joins” and has included a phone number at which to reach the first participant. The first participant response 110 is sent to the meeting server 104, where the meeting server 104 logs the response information of the first participant. In this example, the first participant will be called at the included phone number when the host joins and starts the meeting. The phone number can be that of the first user equipment 108 or another user equipment. In other words, the first participant can participate in the meeting on a user equipment the same as or different than the user equipment from which the first participant sent the response. In one example, the first participant sends the response from a laptop and joins the meeting via the laptop. In another example, the first participant sends the response from a desktop and joins the meeting via a smartphone.

In FIG. 1C, the second participant response 114 is shown. The second participant has selected “Call me at 4:30 pm PST” and has included a phone number at which to reach the second participant. The second participant, as noted above, also included the time at which to call the second participant. The second participant response 114 is sent to the meeting server 104, where the meeting server 104 logs the response information of the second participant. In this example, the second participant will be called at the included phone number when the host joins and starts the meeting. The phone number can be that of the second user equipment 112 or another user equipment. In other words, the second participant can participate in the meeting on a user equipment the same as or different than the user equipment from which the second participant sent the response. In one example, the second participant sends the response from a laptop and joins the meeting via the laptop. In another example, the second participant sends the response from a desktop and joins the meeting via a smartphone.

Though a phone number is discussed herein, the disclosure is not intended to be so limited. The one or more participants' contact information includes, without limitation, a phone number, an e-mail address, a video conferencing address, a video conferencing number, an IP address, a MAC address, and the like, or combinations thereof.

FIG. 1D shows a block diagram of the meeting server 104. The meeting server includes a scheduling module 120, including a schedule database 130, and a conferencing module 140. The meeting server 104 also includes a network module 150. The schedule database 130 stores meeting information 132, including, without limitation, meeting name, meeting time, meeting location, call-in information, and any other appropriate information for scheduling or identifying the meeting. The schedule database 130 also stores participant response information 134, such as the information of the first and second participant responses 110, 114. In one embodiment, the first and second participant responses 110, 114 are received from the first and second user equipment 108, 112 by the network module 150, such as via one or more network protocols. The participant response information 134 can be extracted from each of the first and second participant responses 110, 114 by an extraction module 160, the extraction module 160 having been programmed to extract participant response information 134 from the first and second participant responses 110, 114. The participant response information 134 is then transmitted to and stored within the schedule database 130. For example, the meeting server 104 generates, transmits, or both, an instruction to store meeting information 132 and participant response information 134 within the schedule database 130. The meeting server 104 generates, transmits, or both an instruction to extract the participant response information 134 from the response by the extraction module 160.

The schedule database 130 logs the meeting information 132 and the participant response information 134. The data and information can be stored in any appropriate format, standard, or table. For example, the data and information can be stored in comma separated value tables, fielded text, data interchange format, HTML sourced data, JQuery, Bootstrap, or the like.

When a condition of the first or second participant responses 110, 114 is met, as determined by the scheduling module 120, the scheduling module 120 sends a signal or instruction to the conferencing module 140, the network module 150, or both, to contact the first and second participant user equipment 108, 112 and place the first and second participant user equipment 108, 112 into conference, via the conferencing module 140, with the host user equipment 102 or another user equipment, such as by, for example, SIP or TRP. The conferencing module 140 can support audio 142, video 144, text 146, images 148, or combinations thereof.

The network module 150 is programmed to communicate, via one or more network protocols, with another device, such as the host user equipment 102, the first participant user equipment 108, and the second participant user equipment 112, through a physical connection, such as a local area network (LAN), Universal Serial Bus (USB), or the like, or a wireless connection, such as Bluetooth®, WiFi, wireless networks, or the like. For example, the host user equipment 102 communicates with the meeting server 104 via a wireless wide area network; and, the first participant user equipment 108 communicates with the meeting server 104 via the same wireless wide area network.

The meeting server 104 can also include one or more additional processing circuitries (not shown) programmed to process received inputs, to extract data or information from the received inputs, to form lists, to use extracted data or information in decision trees, to output data, information, or requests, and the like, or combinations thereof.

The various modules or databases 120, 130, 140 or one or more processing circuitries (not shown) can be removable or replaceable, allowing replacement and addition of various elements when it is desirous to do so. In example embodiments, all or a portion of the modules, databases, or circuitry can be in a single server or spread across multiple servers, the multiple servers being in communication with at least one other server to obtain the same results as if the modules, databases, or circuitry were in a single server.

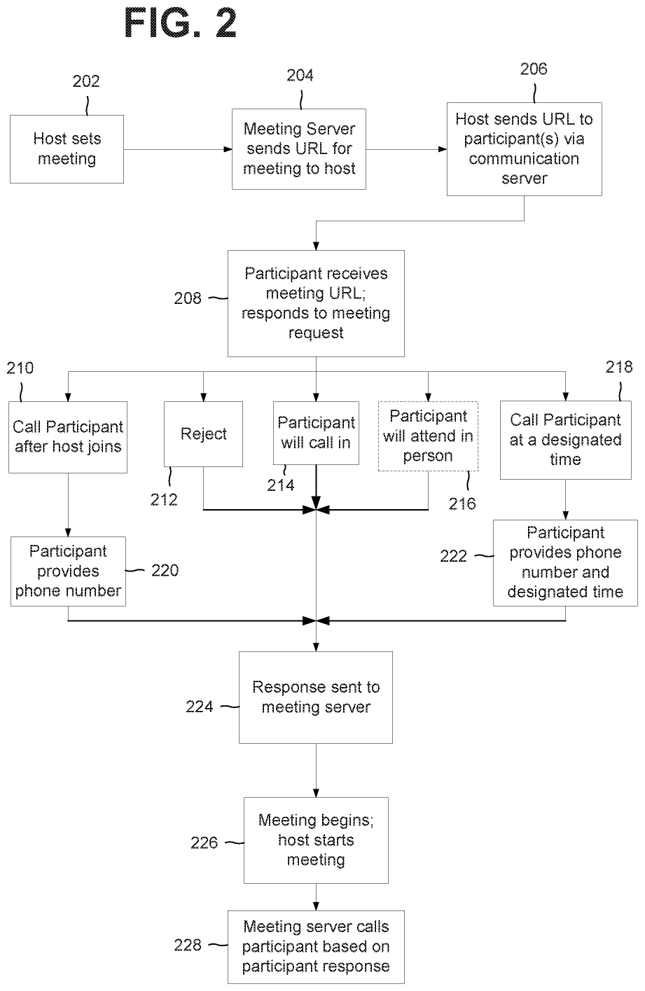

FIG. 2 shows a flowchart for scheduling and joining a meeting. At 202, the host sets the meeting. The host, via the host user equipment 102, sends information about the meeting (e.g., meeting name, meeting time, meeting location, call-in information, and any other appropriate information for scheduling or identifying the meeting) to the meeting server 104. The meeting server 104 logs the meeting information in the schedule database 130.

At 204, the meeting server 104 sends a URL for the scheduled meeting to the host, via the host user equipment 102. At 206, the host, via the host user equipment 102, sends the URL to one or more participant user equipment 108, 112 via the communication server 106. The URL can be sent by e-mail, text (including real-time text), audio (including with touch tones), or any appropriate method or protocol by which a response from the first participant user equipment 108 can be received.

At 208, the one or more participants receives, via the one or more participant user equipment 108, 112, the meeting URL. In one embodiment, the participant clicks on the included link to open a response box or to be forwarded to a response page for the associated meeting. For example, the meeting request is received as an e-mail with an included link. Upon clicking the link, the participant is sent to a page or a pop-up window that includes the one or more response options. Though the meeting URL is discussed, a meeting request can be transmitted via a message with one or more response options integrated during transmission from the host user equipment 102 to the first or second participant user equipment 108, 112 via one or more protocols. For example, the meeting request is received as an e-mail with one or more response options integrated into the received e-mail.

Furthermore, at 208, the participant responds to the meeting request. At 210-218, one or more response options are available for selection: “Call me after host joins,” “Reject,” “I will call in,” “Accept (in person),” and “Call me at [insert time].” At 220, when “Call me after host joins” is selected, the participant includes a phone number at which to call the participant after the host joins or starts the meeting. At 222, when “Call me [insert time]” is selected, the participant includes a phone number at which to reach the participant and the time at which to call the participant.

When the response options 212-216 are selected or after participant includes the necessary information 220, 222, the response is sent to the meeting server 104. The meeting server 104 logs the responses in the participant response 124 of the schedule database 130 of the scheduling module 120.

At 226, the host, via the host user equipment 102 and the meeting server 104, starts the meeting. At 228, the meeting server 104 calls the participant, such as via the network module 150, based on the response included and places the host and participant into conference, such as by the conferencing module 140 of the scheduling module 120, via the conference communication link.

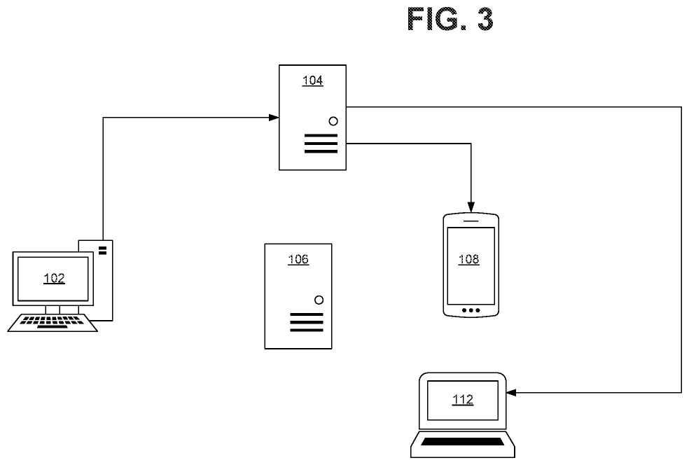

FIG. 3 shows a system to call one or more participants of the meeting. After the host, via the host user equipment 102, initiates the meeting by communicating with the meeting server 104, the meeting server 104 calls the first participant user equipment 108, based on the first participant response 110, at the included phone number. The meeting server 104 calls the second user equipment 112, based on the second participant response 114, at the included phone number and at the designated time.

In one embodiment, when a meeting time is changed, the meeting server 104 is programmed to request new responses from one or more of the participants. For example, the meeting server 104 is programmed to compare the initial participant responses 110, 114 against the new time of the meeting. When a new meeting time falls outside the range of the initial meeting time or the new meeting is designated to start after a participant's designated call back time, the meeting server 104 requests a new response from the participant who initially responded to be called at a designated time. The meeting server 104 retains the initial responses from all other participants. In another example, the meeting server 104 requests new responses from all participants. In yet another example, the meeting server 104 requests new response from one or more of the participants.

In another embodiment, the host, via the host user equipment 102 and the communication server 106, can request new responses from one or more of the participants, similarly to the request of the meeting server 104. The response or responses to the new request can be sent to and logged by the meeting server 104.

Embodiments of the invention can include a non-transitory computer readable medium which can store instructions for performing the above-described methods and any steps thereof, including any combinations of the same. For example, the non-transitory computer readable medium can store instructions for execution by one or more processors or similar devices.

Further embodiments of the present invention can also include the one or more user equipment(s) or servers which read out and execute computer executable instructions, such as a non-transitory computer-readable medium, recorded or stored on a storage medium (which may be the same as or different than the storage medium for storing images or files, as discussed above), to perform the functions of any embodiment. The user equipment or server may include one or more of a central processing unit (CPU), micro processing unit (MPU), or other circuitry, such as a processor, and may include a network of separate user equipment or servers or separate computer processors. The computer executable instructions may be provided to the user equipment or server, for example, from a network or the storage medium.

Though the meeting server 104 is discussed as being a single server, the disclosure is not intended to be so limited. The meeting server 104 can include more than server in communication via server to server protocol with each server programmed to perform one or more functions or steps and to include one or more protocols.

Though “meeting” is used herein, the disclosure is not intended to be so limited. The meeting can be a conference call, a web conference, or the like.

Though “call” is used herein, the disclosure is not intended to be limited. The participant can be contacted in any appropriate manner or method to join and connect to the meeting, including, without limitation, audio, video, text, or combinations thereof.

Though certain elements, aspects, components or the like are described in relation to one embodiment or example for calling a meeting participant, those elements, aspects, components or the like can be included with any other calling or notification method, such as when it desirous or advantageous to do so.

Though a host and two participants are discussed herein, the disclosure is not intended to be so limited. The number of participants can be any number of desired participants, including, without limitation, 1, 2, 3, 4, 5, 6, 7, 8, 9, 10, 20, 25, 30, 40, 50, 60, 70, 80, 90, 100, at least 1, at least 2, at least 3, at least 4, at least 5, at least 6, at least 7, at least 8, at least 9, at least 10, at least 20, at least 25, at least 30, at least 40, at least 50, at least 60, at least 70, at least 80, at least 90, at least 100, up to 2, up to 3, up to 4, up to 5, up to 6, up to 7, up to 8, up to 9, up to 10, up to 20, up to 25, up to 30, up to 40, up to 50, up to 60, up to 70, up to 80, up to 90, up to 100, or the like.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents:

1. A system to cause a participant user equipment to join a meeting, comprising:
a communication server programmed to:
receive a meeting request from a host user equipment,
generate a meeting invitation based on the meeting request, and
transmit the meeting invitation to the participant user equipment; and
a meeting server programmed to:
receive a response to the meeting invitation from the participant user equipment, the response including:
an acceptance of the meeting, and
a meeting connection condition for the participant user equipment, the meeting connection condition including an instruction for the participant user equipment to join the meeting in response to the host user equipment initiating the meeting,
receive an instruction from the host user equipment to initiate the meeting associated with the meeting invitation, and
in response to the host user equipment initiating the meeting, connect the participant user equipment to the meeting based on the acceptance of the meeting and the connection condition.

2. The system of claim 1, wherein the communication server and the meeting server are the same server.

3. The system of claim 1, wherein the response to the meeting invitation further comprises contact information of the participant user equipment.

4. The system of claim 3, wherein the contact information is a phone number, an e-mail address, a video conferencing address, a video conferencing number, an IP address, a MAC address, or any combination or multiples thereof.

5. The system of claim 3, wherein the response to the meeting invitation further comprises a pre-determined time at which the meeting is scheduled to begin.

6. The system of claim 1, wherein causing the participant user equipment to connect to the meeting comprises calling the participant user equipment, joining the participant user equipment by video, or both.

7. The system of claim 1, wherein the meeting server further includes a scheduling module having a conferencing module programmed to initiate the conference communication link between the host user equipment and the participant user equipment.

8. The system of claim 7, wherein the meeting server is further programmed to generate an instruction to store meeting information and participant response information within the scheduling database.

9. The system of claim 7, wherein the meeting server further comprises a network module programmed to communicate with an external device.

10. The system of claim 9, wherein the external device is the host user equipment, the participant user equipment, or both.

11. The system of claim 8, wherein the meeting server is further programmed to generate an instruction to extract the participant response information from the response by an extraction module.

12. The system of claim 1, wherein the host user equipment is a smartphone, a mobile phone, a telephone, a tablet, a personal digital assistant, a laptop, or a desktop.

13. The system of claim 1, wherein the participant user equipment is a smartphone, a mobile phone, a telephone, a tablet, a personal digital assistant, a laptop, or a desktop.

14. The system of claim 1, wherein the participant user equipment is programmed to send the response to the meeting server.

15. The system of claim 1, wherein the host user equipment is programmed to:
send meeting information to the meeting server; and
cause the communication server to send the meeting invitation to the participant user equipment.

16. The system of claim 1, wherein the participant user equipment is programmed to:
receive the meeting invitation; and
send the response to the meeting invitation to the meeting server.

17. The system of claim 1, wherein the meeting server further comprises:
one or more network protocols to communicate with the host user equipment and the participant user equipment;
one or more network protocols to transmit data between the meeting server and the host user equipment, between the meeting server and the participant user equipment, or both;
one or more network protocols for sending, distributing, receiving, or transferring an e-mail or a file; or,
combinations or multiples thereof.

18. The system of claim 1, wherein the meeting server is further programmed to extract participant response information from the response to the meeting invitation.

19. The system of claim 1, wherein the conference communication link comprises a telephone conference or a video conference.

20. A system for joining participants to a meeting, comprising:
a communication server programmed to:
receive a meeting request from a host user equipment,
generate a meeting invitation based on the meeting request, and
transmit the meeting invitation to a first participant user equipment associated with a participant; and
a meeting server programmed to:
receive a response to the meeting invitation from the first participant user equipment, the response including:
an acceptance of the meeting, and
a meeting connection condition that includes an instruction for a second participant user equipment associated with the participant to join the meeting in response to the host user equipment initiating the meeting,
receive an instruction, via the host user equipment, to initiate the meeting associated with the meeting invitation, and
in response to the host user equipment initiating the meeting, connect the second participant user equipment to the meeting based on the acceptance of the meeting and the meeting connection condition,
wherein the first participant user equipment and the second participant user equipment are not the same device.
